(19) United States
(12) Patent Application Publication
(10) Pub. No.: US 2013/0086777 A1
(43) Pub. Date: Apr. 11, 2013

(54) Adjustable holding device and associated adjustable connection mechanism

(71) Applicants: James McLaughlin, New Lenox, IL (US); Margaret Fitzpatrick, New Lenox, IL (US)

(72) Inventors: James McLaughlin, New Lenox, IL (US); Margaret Fitzpatrick, New Lenox, IL (US)

(21) Appl. No.: 13/457,731

(22) Filed: Apr. 27, 2012

Related U.S. Application Data
(60) Provisional application No. 61/627,178, filed on Oct. 7, 2011.

(51) Int. Cl. F16B 2/22

(52) U.S. Cl. CPC F16B 2/22
USPC 24/546

(57) ABSTRACT

The invention relates to a clip device and system for securing ornamental lights, wires, and wired or wireless devices to a rain gutter downspout without damaging the downspout. The retaining device is comprised of a plastic or metal clip. The clip is molded or formed to fit the surface of the rain gutter downspout and securely supports a wires and/or devices on the surface of the downspout.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The present invention relates to a downspout retaining device, and more particularly to a retaining device for an ornamental lights to a gutter downspout. The downspout-retaining device is formed to clip on the front and sides of a gutter downspout securely. An electrical wire or wires with patterned light receptacles fasten to securements on said clip. When placed on the downspout it gives the elusion that the lights are barber poling the downspout.

### BACKGROUND OF THE INVENTION

The current state of knowledge is as follows. The use of ornamental lights on the exterior of residential and commercial structures is common, especially during the traditional holiday season around the times of Christmas and New Year's Eve. Similar lights are often used seasonally or year round, both by businesses and municipalities. The use of holiday lights during other occasions such as Halloween, St. Patrick's Day and Easter is also on the rise.

Ornamental lights commonly take the form of a string of electrical cord with a plurality of small white or colored bulbs interspersed along the cord. Cord lengths can vary between 25 to 200 feet. Bulbs can be of the LED or incandescent variety, and bulb sizes vary between miniature (smallest) and C9 (largest), and also now exist in specialized shapes, such as icicles.

Ornamental light cords are commonly attached to the edifices of buildings, both residential and commercial, often to the gutters and downspouts that tend to frame building walls. Methods of attachment are often ad hoc, including “twist-tie” style wire, suction cups, hooks, staples or similar binding devices. These devices are not designed specifically to accommodate the hanging of ornamental lights and no such device attaches equally well to different types of housing material. The use of many such devices, including but not limited to pins, staples, screws or nails, also creates damage or permanent marks to features of the building edifice.

What is needed is a stable but temporary device for hanging holiday lights on a building edifice that is simple to mount, simple to remove and does not damage the surface to which it is attached.

### BRIEF SUMMARY OF THE INVENTION

The present invention can be used to:

This invention describes the use of

In a preferred embodiment, a clip device for securing ornamental lights comprising a C-shaped clip with a forward face and two side arms, further comprising an interior surface molded to fit the surface of a rain gutter downspout, such side arms exerting inward pressure against the downspout allowing it to secure one or more wires between the clip and the surface of the downspout.

In another preferred embodiment, the interior surface of the clip device is molded or formed to fit tightly against the exterior of a corrugated rain gutter downspout.

In another preferred embodiment, protrusions of the molded clip are to be fitted into the depressions of a corrugated rain gutter downspout, and such protrusions comprise a coating of rubber or synthetic polymer to increase friction.

In another preferred embodiment, the side arms of the clip device extend from the forward face at an angle of less than 90°.

In another preferred embodiment, magnets are adhered to the interior surface of the clip device for additional attachment capability.

In another preferred embodiment, a channel is molded within the clip body and opening to the clip's interior or exterior surface, of sufficient gauge to enable the threading of wire from the group including but not limited to: an ornamental light wire, an extension cord, a power cord for external lighting, a power cord for non-lighting appliances, communications cords for antennas, thermometers, or similar appliances, coaxial cable or telephone wire.

In another preferred embodiment, a velcro strap for securing wire is adhered to the clip body.

In another preferred embodiment, metal or plastic clips or fasteners for securing wire are molded into or adhered to the clip body.

In another preferred embodiment, ties or tethers for securing wire are adhered to the clip body.

In another preferred embodiment, the clip further comprises a rear face connecting the dorsal ends of the side arms, such rear face being hinged on one corner and latched on the other.

In another preferred embodiment, the device itself is used as a point of attachment or mounting for ornamental or utilitarian devices to avoid damage to the downspout from the mounting process.

In another preferred embodiment, a clip device for securing ornamental lights: (1) comprising a C-shaped clip with an interior surface molded to fit tightly against the surface of a corrugated rain gutter downspout, such clip exerting pressure on the downspout allowing it to secure one or more wires between the clip and the surface of the downspout; (2) optionally comprising one or more channels molded within the clip body and opening to the clip's interior or exterior surface, of sufficient gauge to enable the threading of one or more wires; (3) optionally comprising one or more features of the following group: a velcro strap for securing wire adhered to the the clip body, metal or plastic clips or fasteners for securing wire molded into or adhered to the clip body, ties or tethers for securing wire are adhered to the clip body.

In another preferred embodiment, a system for securing one or more wires to a rain gutter downspout, comprising a plurality of the clip devices of claim 1, further comprising wherein one or more wires are secured to the downspout at intervals and held by the pressure between each clip and the downspout.

In another preferred embodiment, the system of the above paragraph, further comprising wherein each clip body comprises one or more channels within the clip body opening to either the clip's interior or exterior surface, each channel of sufficient gauge to enable the threading of wire from the group including but not limited to: an ornamental light wire, an extension cord, a power cord for external lighting, a power cord for non-lighting appliances, communications cords for antennas, thermometers, or similar appliances, coaxial cable or telephone wire.

### BRIEF DESCRIPTION OF THE DRAWINGS

FIG. 1 is a line drawing evidencing a perspective view of the clip device.

FIG. 2 is a line drawing evidencing a front view of the clip device.

FIG. 3 is a line drawing evidencing a top view of the clip device.

FIG. 4 is a line drawing evidencing a plurality of clip devices clamped onto a rain gutter downspout and affixing a line of ornamental lights in a barber pole design.

### DETAILED DESCRIPTION OF THE INVENTION

### Definitions

The following definitions are provided as an aid to understanding the detailed description of the present invention.

Ornamental or holiday lights are normally attached to gutters, roof edges, fences, or other objects. However, to create a “barber pole” diagonal wrapped pattern, the lights must be wrapped around the object to achieved the desired pattern.

Additionally, lights and other electrical devices and appliances are often attached to the upper portions of structures and require the use and installation of power and communication cord(s) to provide power and connectivity to such devices high off the ground. Examples of such devices include, without limitation, security cameras, weather measurement devices, and motion or light detectors.

The primary objective of the clip device is to provide a mechanism for securing wires to a rain gutter downspout without having to wrap or use ad hoc tools or fasteners. In a preferred embodiment, the clip device comprises a three-sided downspout retaining clip of molded plastic, formed to fit securely on the front surface of the sides and face of a downspout. The clip is shaped of a flat piece of molded plastic with two molded bends. In a preferred embodiment, the body of the clip device is approximately 0.10″-1.0″ deep and approximately 0.5″-6″ in height. In a more preferred embodiment, the body of the device is approximately 0.13″-0.5″ deep and approximately 1.0″-3.0″ in height.

On either side of the forward face, the clip device is bent to extend rearward, forming side arms for gripping the sides of a downspout. The bends can be rounded or cornered, and extend rearward to form an angle with the forward face of less than 90°. In a preferred embodiment the angle of each side arm to the forward face is 60°-89°. In a more preferred embodiment, the angle is 75°-85°. The angle of the side arms places pressure on the sides of the downspouts to secure and stabilize the clip.

In another preferred embodiment, the clip is further stabilized by the attachment of one or more magnets to the interior surface of the clip, using an adhesive from among the group including: polyester resin, polyols, acrylic polymers, cyanoacrylates, polyepoxides, or another synthetic or natural adhesive known in the art.

The exterior surface of the clip is smooth. The interior surface of the forward face and the rounded bends is also smooth, with a series of inward-facing protrusions emanating from the rear portion of each side arm. These emanations aid the device in gripping the downspout, and are sized and spaced in such a way to interplay with the form of downspouts, which are often constructed of corrugated metal. In a preferred embodiment, there are three such emanations on each side, each approximately 0.05″-“0.3” in breadth and raised approximately 0.05″-0.5″ from the inner surface of the side arm.

Commercially available rain gutter downspout assemblies come in a variety of dimensions, depending on the size of the roof and the number of downspouts used in the gutter system. Downspout dimensions may vary depending on commercial versus residential application. In a preferred embodiment, the dimensions of the clip device may be sized up or down to accommodate standard downspouts of such varied sizes.

In another preferred embodiment, the width of the front face of the clip device, in combination with the curved portions on either side, measures slightly more than the width of the face of a standard size downspout. In a more preferred embodiment, such width exceeds such downspout width by approximately 0.2″ to 1.0″.

In another preferred embodiment, the length of each side arm of the clip device is identical, and in each event, in combination with the curved portions attaching each side arm to the front face, approximates the depth of a standard size downspout.

The space between the emanations also provides areas through which the wires of ornamental lights or other wires may be threaded. In one preferred embodiment, the inter-emanation spaces are used to thread wire on one side, with the wire then extending beneath the clip to the other side and threaded through the inter-emanation space on that side, before being threaded across the downspout face to the next clip location, continuing therefrom up or down the downspout.

In another preferred embodiment, a channel is molded into the body of the clip, opening into the interior surface, through which a wire may be threaded.

In another preferred embodiment, the inter-emanation spaces in a plurality of clips can be used to run an extension cord up the side of a downspout to reach devices requiring power on or around the roof area.

Downspouts tend to be of uniform shape and size, but adjustable sizing for the device is possible. In another preferred embodiment, similar proportions are maintained while the clip itself is sized upward or downward to accommodate downspouts of different dimensions.

In another preferred embodiment, a rear face is added to the clip device so that it becomes four-sided and circumnavigates the downspout. In such embodiment, one corner between a side arm and the rear face would be flexible or hinged, while the opposite corner between the other side arm and the rear face would be latched. Potential methods of latching would include, without limitation: clips, snaps, or Velcro, whether adhered to the clip device or molded into it.

In other preferred embodiments, the clip device might would have one or more attachments or features for securing wires, including but not limited to: velcro straps, metal or plastic clips or fasteners, ties or tethers.

Said clip is molded to secure the electrical wire or wires between the clip and the surface of the downspout. These wires will sometimes have a pattern of light receptacles and a predetermined length between them. The wire lengths between the lights receptacles are attached to clip.

In another preferred embodiment, the clip device itself is used as a point of attachment or mounting for ornamental or utilitarian devices. By way of example without limitation, an outdoor thermometer or solar panel could be attached to the device utilizing a bracket or other mounting structure, either forming a part of the device or mounted separately. Similarly, a sculpted and or painted decoration or set of decorations could be similarly mounted. In such embodiment, damage to the downspout from such mounting would be avoided.

The clip device allows ornamental lights to appear to wrap around the downspout when in actuality they are clipped in the front and sides. Wires passing around the clip and allowing the lights to appear to wrap around the downspout acquire this barber poling affect. The downspout-retaining device also used as an extension cord.

Types of plastic available for clip construction include polypropylene, polyethylene, plasticized PVC and other vinyls, PVBs, synthetic rubber and Bakelite, expandable polytetrafluoroetheylene (ePTFE), polyester and polyurethane as well as other appropriate polymers known in the art. In a preferred embodiment, the clip device is constructed of polypropylene.

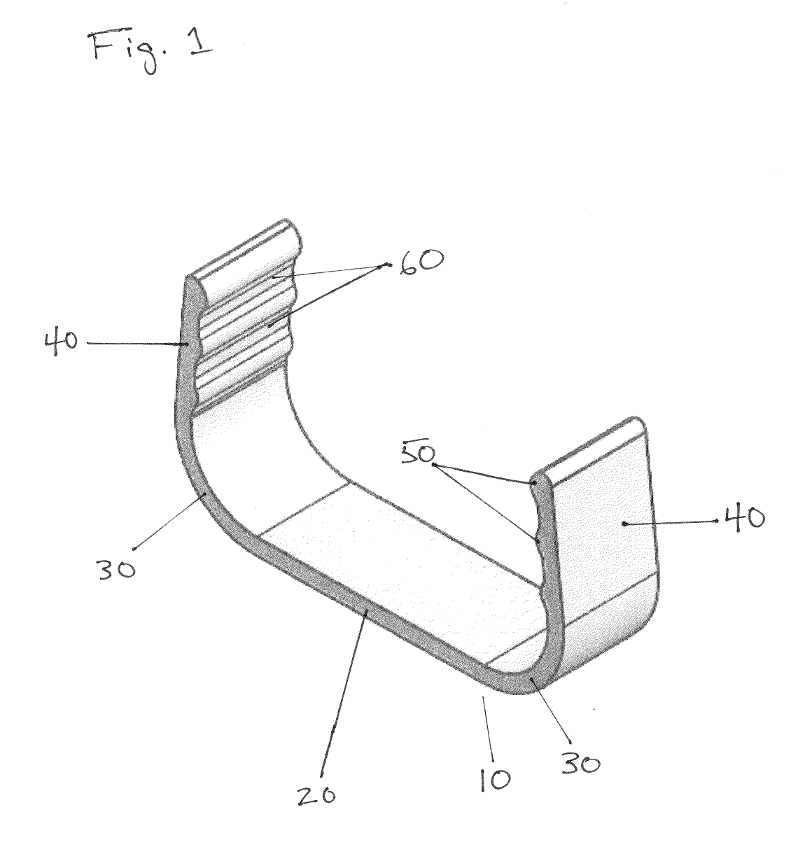

Turning now to the Figures, FIG. 1 is a line drawing evidencing a perspective view of clip device 10, showing the inner surface of the forward face 20, extending curves 30, the inner surface of farther side arm 40 and the outer surface of nearer side arm 40 as each extends at a less than 90° angle from forward face 20. FIG. 1 further evidences a full view of the emanations 50 and inter-emanation spaces 60 of the farther side arm 40, and a profile of the emanations 50 and inter-emanation spaces 60 of the nearer side arm 40.

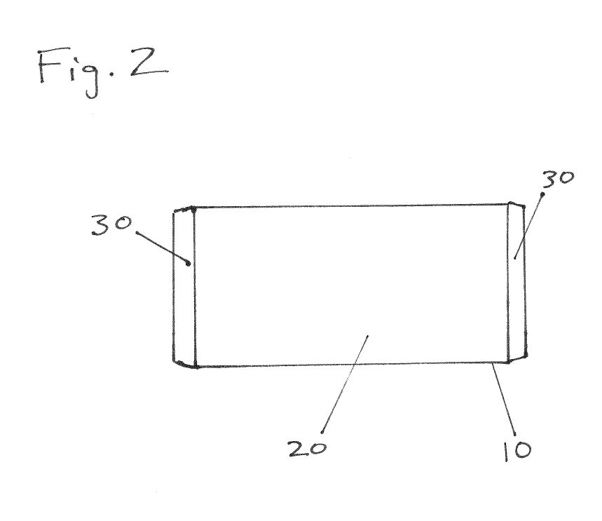

FIG. 2 is a line drawing evidencing a front view of clip 10 evidencing forward face 20 and the extending curves 30.

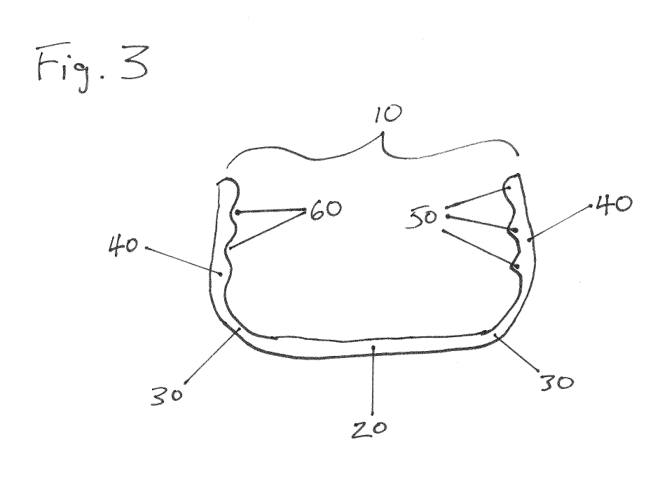

FIG. 3 is a line drawing evidencing a top view of clip 10, and evidencing forward face 20, curves 30, side arms 40, emanations 50 and inter-emanation space 60.

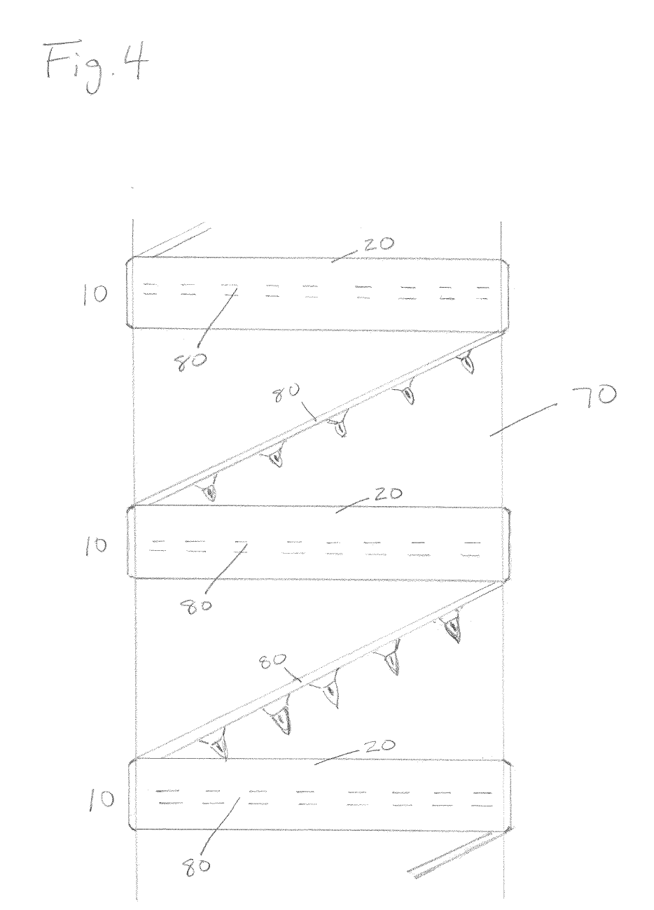

FIG. 4 is a line drawing evidencing a plurality of clips 10 clamped onto a rain gutter downspout 70 and affixing a wire of ornamental lights 80 in a “barber pole” design. The ornamental light wire 80 is not visible where it crosses behind the front face 20 of each clip device 10, and is evidenced by dotted lines in those locations.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

What is claimed:

1. A device for securing ornamental lights comprising a C-shaped clip with a forward face and two side arms, further comprising an interior surface molded to fit the surface of a rain gutter downspout, such side arms exerting inward pressure against the downspout allowing it to secure one or more wires between the clip and the surface of the downspout.

2. The clip device of claim 1, further comprising wherein the interior surface is molded or formed to fit tightly against the exterior of a corrugated rain gutter downspout.

3. The clip device of claim 2, further comprising wherein protrusions of the molded clip are to be fitted into the depressions of a corrugated rain gutter downspout, and such protrusions comprise a coating of rubber or synthetic polymer to increase friction.

4. The clip device of claim 1, further comprising wherein the side arms extend from the forward face at an angle of less than 90°.

5. The clip device of claim 1, further comprising wherein magnets have been adhered to the interior surface of the clip for additional attachment capability.

6. The clip device of claim 1, further comprising a channel within the clip body and opening to the clip's interior or exterior surface, of sufficient gauge to enable the threading of wire from the group including but not limited to: an ornamental light wire, an extension cord, a power cord for external lighting, a power cord for non-lighting appliances, communications cords for antennas, thermometers, or similar appliances, coaxial cable or telephone wire.

7. The clip device of claim 1, further comprising wherein a velcro strap for securing wire is adhered to the clip body.

8. The clip device of claim 1, further comprising wherein metal or plastic clips or fasteners for securing wire are molded into or adhered to the clip body.

9. The clip device of claim 1, further comprising wherein ties or tethers for securing wire are adhered to the clip body.

10. The clip device of claim 1, further comprising a rear face connecting the dorsal ends of the side arms, such rear face is hinged on one corner and latched on the other.

11. The clip device of claim 1, further comprising wherein the device itself is used as a point of attachment or mounting for ornamental or utilitarian devices to avoid damage to the downspout from the mounting process.

12. A clip device for securing ornamental lights: (1) comprising a C-shaped clip with an interior surface molded to fit tightly against the surface of a corrugated rain gutter downspout, such clip exerting pressure on the downspout allowing it to secure one or more wires between the clip and the surface of the downspout; (2) optionally comprising one or more channels molded within the clip body and opening to the clip's interior or exterior surface, of sufficient gauge to enable the threading of one or more wires; (3) optionally comprising one or more features of the following group: a velcro strap for securing wire adhered to the the clip body, metal or plastic clips or fasteners for securing wire molded into or adhered to the clip body, ties or tethers for securing wire are adhered to the clip body.

13. A system for securing one or more wires to a rain gutter downspout, comprising a plurality of the clip devices of claim 1, further comprising wherein one or more wires are secured to the downspout at intervals and held by the pressure between each clip and the downspout.

14. The system of claim 13, further comprising wherein each clip body comprises one or more channels within the clip body opening to either the clip's interior or exterior surface, each channel of sufficient gauge to enable the threading of wire from the group including but not limited to: an ornamental light wire, an extension cord, a power cord for external lighting, a power cord for non-lighting appliances, communications cords for antennas, thermometers, or similar appliances, coaxial cable or telephone wire.
